(19) United States
(12) Patent Application Publication
(10) Pub. No.: US 2026/0119911 A1
(43) Pub. Date: Apr. 30, 2026

(54) A SYSTEM AND METHOD FOR POTENTIAL BIAS IDENTIFICATION

(71) Applicant: PRIVYA OPS LTD, Modi'in-Maccabim-Re'ut (IL)

(72) Inventor: Uzy HADAD, Modi'in-Maccabim-Re'ut (IL)

(21) Appl. No.: 19/164,223

(22) PCT Filed: Mar. 21, 2024
(86) PCT No.: PCT/IL2024/050293

§ 371 Date: Sep. 11, 2025

Related U.S. Application Data
(60) Provisional application No. 63/491,538, filed on Mar. 22, 2023.

(51) Int. Cl. G06N 5/022

(52) U.S. Cl. CPC G06N 5/022

(57) ABSTRACT

The described invention is directed to systems and methods capable of identifying Machine Learning (ML) models that are potentially biased. The system obtains: (a) a list of potentially problematic labels, and (b) at least one code segment, including a plurality of code lines containing one or more commands associated with generating at least one machine learning model from a given data structure. The system extracts the actual labels of the given data structure and compares them to the list of potentially problematic labels. Upon a match between at least one of the extracted actual labels and at least one of the potentially problematic labels, the system performs an action associated with the knowledge that the ML model is potentially biased.

### TECHNICAL FIELD

The present invention relates to the field of systems and methods for potential bias identification.

### BACKGROUND

The term “algorithmic bias” is used to describe systematic and repeatable errors in a computer system that create “unfair” outcomes, such as “privileging” one category over another in ways different from the intended function of the algorithm.

Bias can emerge from many factors, including but not limited to the design of the algorithm, the unintended or unanticipated use of the algorithm, or decisions relating to how data is coded, collected, selected, or used to train the algorithm. For example, Bias can enter into algorithmic systems due to (i) pre-existing cultural, social, or institutional expectations, (ii) because of technical limitations of their design, or (iii) by being used in unanticipated contexts or by audiences who are not considered in the software's initial design.

With the expansion of algorithms' ability to organize society, politics, institutions, and behavior, there has been an ever-growing concern about how unanticipated output and manipulation of data can impact the physical world. Algorithmic bias has already been cited in cases ranging from election outcomes to the spread of online hate speech. In addition, it has also arisen in criminal justice, healthcare, and hiring, compounding existing racial, socioeconomic, and gender biases.

Nowadays, existing and newly proposed Data Privacy Protection regulations require companies to perform algorithmic impact assessments. As part of these assessments, said companies need to evaluate if there is algorithmic bias in any of the algorithms they employ. Since current privacy management solutions fail to identify potentially biased algorithms automatically, these solutions leave the companies' officers with the daunting task of manually identifying and assessing these algorithms.

Thus, there is a need in the art for a new system for potential bias identification and method.

### GENERAL DESCRIPTION

In accordance with a first aspect of the presently disclosed subject matter, there is provided a system for potential data bias identification, the system comprising a processing circuitry configured to: obtain: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures; extract the plurality of actual labels from said data structure; and, upon at least one actual label of the plurality of actual labels matching at least one theoretical label of the plurality of theoretical labels, perform an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the extracting step, the processing circuitry is configured to identify at least one code flow of the plurality of code flows in which the data structure is present.

In accordance with a second aspect of the presently disclosed subject matter, there is provided a system for potential data bias identification, the system comprising a processing circuitry configured to: obtain: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is composed of a plurality data records; determine, based on at least some of said plurality data records, a plurality of actual labels; and, upon at least one actual label of the plurality of actual labels matching at least one theoretical label of the plurality of theoretical labels, perform an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the determining step, the processing circuitry is configured to identify at least one code flow of the plurality of code flows in which the data structure is present.

In some cases, the plurality data records are originated from test data.

In accordance with a third aspect of the presently disclosed subject matter, there is provided a system for potential data bias identification, the system comprising a processing circuitry configured to: obtain: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated with a plurality of data queries, each of which is associated with a plurality of data records associated with said data structure; determine a plurality of actual labels by analyzing at least some of said plurality of data queries; and, upon at least one actual label of the plurality of actual labels matching at least one theoretical label of the plurality of theoretical labels, perform an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the determining step, the processing circuitry is configured to identify at least one code flow of the plurality of code flows in which the data structure is present.

In some cases, the plurality data records are originated from test data.

In accordance with a fourth aspect of the presently disclosed subject matter, there is provided a method for potential data bias identification comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures; extracting the plurality of actual labels from said data structure; and, upon at least one actual label of the plurality of actual labels matching at least one theoretical label of the plurality of theoretical labels, performing an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the extracting step, at least one code flow of the plurality of code flows in which the data structure is present, is identified.

In accordance with a fifth aspect of the presently disclosed subject matter, there is provided a non-transitory computer readable storage medium having computer readable program code embodied therewith, the computer readable program code, executable by at least one processor to perform a method for potential data bias identification, the method comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures; extracting the plurality of actual labels from said data structure; and, upon at least one actual label of the plurality of actual labels matching at least one theoretical label of the plurality of theoretical labels, performing an action associated with potential data bias identification.

In accordance with a sixth aspect of the presently disclosed subject matter, there is provided a method for potential data bias identification comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is composed of a plurality data records; determining, based on at least some of said plurality data records, a plurality of actual labels; and, upon at least one actual label of the plurality of actual labels matching at least one theoretical label of the plurality of theoretical labels, performing an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the determining step, at least one code flow of the plurality of code flows in which the data structure is present, is identified.

In some cases, the plurality data records are originated from test data.

In accordance with a seventh aspect of the presently disclosed subject matter, there is provided a non-transitory computer readable storage medium having computer readable program code embodied therewith, the computer readable program code, executable by at least one processor to perform a method for potential data bias identification, the method comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is composed of a plurality data records; determining, based on at least some of said plurality data records, a plurality of actual labels; and, upon at least one actual label of the plurality of actual labels matching at least one theoretical label of the plurality of theoretical labels, performing an action associated with potential data bias identification.

In accordance with an eighth aspect of the presently disclosed subject matter, there is provided a method for potential data bias identification comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated with a plurality of data queries, each of which is associated with a plurality of data records associated with said data structure; determining a plurality of actual labels by analyzing at least some of said plurality of data queries; and, upon at least one actual label of the plurality of actual labels matching at least one theoretical label of the plurality of theoretical labels, performing an action associated with potential data bias identification.

In some cases, the action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

In some cases, at least some of said one or more source data structures are Machine Learning (ML) models generated from data structures other than said data structure.

In some cases, at least some of said one or more source data structures are profiles generated from data structures other than said data structure.

In some cases, the one or more commands are one of: train, transform, fit_transform, or fit.

In some cases, the plurality of theoretical labels include one or more of: race, ethnicity, gender, religion, sexual orientation, age, philosophical belief, political opinion, health, finances, height, weight, or address.

In some cases, the plurality of theoretical labels is a dynamic list of indicators of a potential bias that is constantly updated.

In some cases, the plurality of actual labels include one of: feature labels, target labels, or a combination thereof.

In some cases, each actual label of the plurality of actual labels is associated with additional labels that are also indicative of the content of data records associated with said actual label.

In some cases, (i) the at least one code segment includes a plurality of code flows, each including a plurality of code lines, and (ii) prior to the determining step, at least one code flow of the plurality of code flows in which the data structure is present, is identified.

In some cases, the plurality data records are originated from test data.

In accordance with a nineth aspect of the presently disclosed subject matter, there is provided a non-transitory computer readable storage medium having computer readable program code embodied therewith, the computer readable program code, executable by at least one processor to perform a method for potential data bias identification, the method comprising: obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated with a plurality of data queries, each of which is associated with a plurality of data records associated with said data structure; determining a plurality of actual labels by analyzing at least some of said plurality of data queries; and, upon at least one actual label of the plurality of actual labels matching at least one theoretical label of the plurality of theoretical labels, performing an action associated with potential data bias identification.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an exemplary code segment on which the system for potential bias identification operates, in accordance with the presently disclosed subject matter;

FIG. 2 is a block diagram schematically illustrating one example of a system for potential bias identification, in accordance with the presently disclosed subject matter;

FIG. 3 is a flowchart illustrating an example of a sequence of operations carried out by a system for potential bias identification, in accordance with the presently disclosed subject matter;

FIG. 4 is a schematic illustration of another exemplary code segment on which the system for potential bias identification operates, in accordance with the presently disclosed subject matter;

FIG. 5 is a schematic illustration of yet another code segment on which the system for potential bias identification operates, in accordance with the presently disclosed subject matter;

FIG. 6 is a flowchart illustrating another example of a sequence of operations carried out by a system for potential bias identification, in accordance with the presently disclosed subject matter; and,

FIG. 7 is a flowchart illustrating yet another example of a sequence of operations carried out by a system for potential bias identification, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “extracting”, “performing”, “determining”, “alerting”, “flagging”, “excluding”, or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

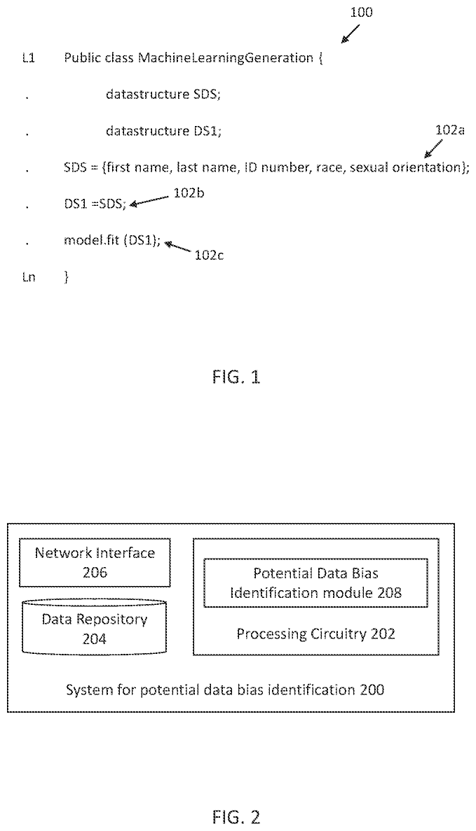

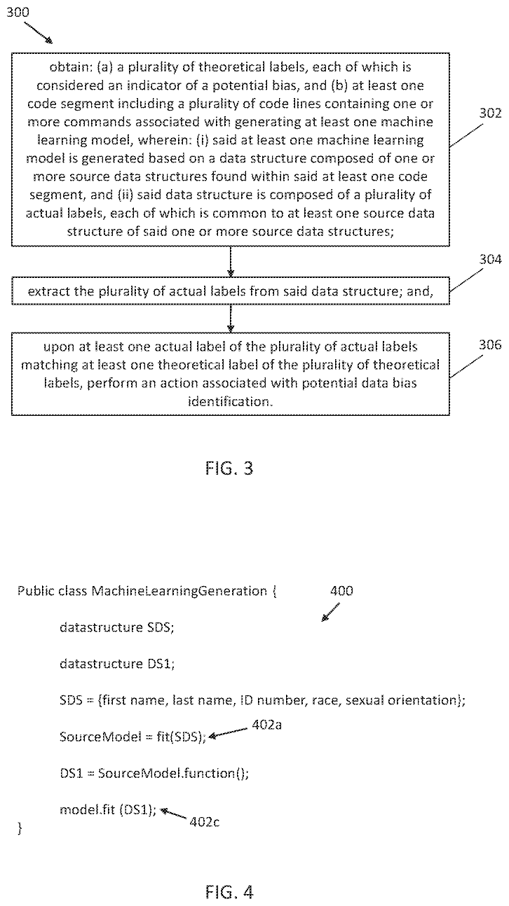

In embodiments of the presently disclosed subject matter, fewer, more and/or different stages than those shown in FIGS. 3, 6, and 7 may be executed. In embodiments of the presently disclosed subject matter one or more stages illustrated in FIGS. 3, 6, and 7 may be executed in a different order and/or one or more groups of stages may be executed simultaneously. FIGS. 1 and 2 illustrate a general schematic of the system architecture in accordance with an embodiment of the presently disclosed subject matter. Each module in FIG. 2 can be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, showing a schematic illustration of a code segment on which the system for potential bias identification operates, in accordance with the presently disclosed subject matter.

As shown in the schematic illustration, code segment 100 includes a plurality of code lines, denoted “L1” to “Ln” (‘n’ representing any number), forming a set of instructions intended to facilitate specific actions to be executed by a computer (not shown). The plurality of code lines, which can be written in any programing language, such as Java, C#, TypeScript, Go, Kotlin, Scala, JavaScript, C++, C Language, Python, PHP Hypertext Preprocessor (PHP), Structured Query Language (SQL), to name a few, may be arranged in one or more code flows and include the use of one or more commands associated with generating of one or more machine learning (ML) models (e.g., train, transform, fit_transform, fit, to name a few though any other known command may be applicable as well).

Each command of said commands may be directed to be executed on a data structure. The data structure may consist of a plurality of records containing a plurality of values, each of which may be associated with a respective label (e.g., either a feature label or a target label). The plurality of records may originate from one or more source data structures, found either within code segment 100 or derived from a source external to it, such that at least some of the data structure's labels, associated with said values of said records, may be common to at least one source data structure of the source data structures. In one non-limiting example, a data structure may include a plurality of records, originating from several source data structures, containing a plurality of values defining different characteristics of an individual, associated with different feature labels (e.g., race, ethnicity, gender, religion, sexual orientation, age, etc.). Among the different characteristics, at least some characteristics may be common to both the data structure and at least some of the several source data structures.

Of the respective labels of the data structure (and/or of the source data structures composing it), one or more labels may be considered problematic or controversial, as their presence within a data structure (i.e., either the data structure or a given source data structure), as well as of the data to which they are associated, may at least imply that the data structure may potentially be biased or discriminatory. By virtue of this, any ML model generated based on said data structure may also be considered potentially biased.

For example, as illustrated in FIG. 1, code segment 100 may include several steps, including the following steps: at a first stage, denoted 102a, code segment 100 may involve receiving a source data structure by a respective variable, denoted “SDS”. The received source data structure may consist of a plurality of records containing a plurality of values associated with the following feature labels: “first name”, “last name”, “ID number”, “race”, and “sexual orientation”. At a second step, denoted 102b, code segment 100 may involve receiving of said source data structure variable, “SDS”, by a data structure variable, denoted “DS1”. At a third stage, denoted 102c, code segment 100 may involve generating a ML model, denoted “ML1”, from said data structure variable, “DS1”, using a single command, a “Fit” command.

To determine whether the ML model, “ML1”, is biased, the system for potential bias identification of the presently disclosed subject matter operates on code segment 100, as will be described hereafter in reference to FIG. 3.

Attention is now drawn to a description of the components of the system for potential bias identification 200.

FIG. 2 is a block diagram schematically illustrating one example of the system for potential bias identification 200, in accordance with the presently disclosed subject matter.

In accordance with the presently disclosed subject matter, the system for potential bias identification 200 (also interchangeably referred to herein as “system 200”) can comprise a network interface 206. The network interface 206 (e.g., a network card, a Wi-Fi client, a Li-Fi client, 3G/4G client, or any other component), enables system 200 to communicate over a network with external systems and handles inbound and outbound communications from such systems. For example, system 200 can receive, through network interface 206, a plurality of theoretical labels, each of which is considered an indicator of a potential bias.

System 200 can further comprise or be otherwise associated with a data repository 204 (e.g., a database, a storage system, a memory including Read Only Memory-ROM, Random Access Memory-RAM, or any other type of memory, etc.) configured to store data. Some examples of data that can be stored in the data repository 204 include:
One or more code segments;
One or more machine learning models;
One or more data structures;
One or more source data structures;
One or more theoretical labels;
One or more actual labels;
One or more action associated with potential data bias identification;
One or more commands associated with generating at least one machine learning model; etc.

Data repository 204 can be further configured to enable retrieval and/or update and/or deletion of the stored data. It is to be noted that in some cases, data repository 204 can be distributed, while the system 200 has access to the information stored thereon, e.g., via a wired or wireless network to which system 200 is able to connect (utilizing its network interface 206).

System 200 further comprises processing circuitry 202. Processing circuitry 202 can be one or more processing units (e.g., central processing units), microprocessors, microcontrollers (e.g., microcontroller units (MCUs)) or any other computing devices or modules, including multiple and/or parallel and/or distributed processing units, which are adapted to independently or cooperatively process data for controlling relevant system 200 resources and for enabling operations related to system's 200 resources.

The processing circuitry 202 comprises a potential bias identification module 208, configured to perform a sensitive potential bias identification process, as further detailed herein, inter alia with reference to FIG. 3.

It should be noted that system 200 can operate as a standalone system without the need for network interface 206 and/or data repository 204. Adding one or both of these elements to system 200 is optional and not mandatory, as system 200 can operate according to its intended use in both ways.

Turning to FIG. 3 there is shown a flowchart illustrating one example of operations carried out by the system for potential bias identification 200, in accordance with the presently disclosed subject matter.

Accordingly, the system for potential bias identification 200 (also interchangeably referred to hereafter as “system 200”) can be configured to perform a potential bias identification process 300, e.g., using potential bias identification module 208.

For this purpose, system 200 obtains: (a) a plurality of theoretical labels, each of which is considered an indicator of a potential bias, and (b) at least one code segment including a plurality of code lines containing one or more commands associated with generating at least one machine learning model (block 302).

In relation to the theoretical labels, the plurality of theoretical labels may be either a fixed list of indicators or a dynamic list that is constantly updated. In cases such as the latter, the dynamic list may be updated according to an update schedule, whenever the user decides, or a combination thereof.

In relation to the machine learning model, the at least one machine learning model may be a model generated based on a data structure composed of one or more source data structures found within the at least one code segment, and may be associated of a plurality of actual labels, each of which may be common to at least one source data structure of the one or more source data structures.

In some cases, at least some of the one or more source data structures composing said data structure may be ML models generated from data structures other than said data structure. For example, as illustrated in FIG. 4, code segment 400 may include several steps, including the following steps: at a first stage, denoted 402a, code segment 400 may involve generating of a source model, denoted “SM1”, by executing a Fit command on a source data structure variable, denoted “SDS”, including a plurality of records containing a plurality of values associated with the following feature labels: “first name”, “last name”, “ID number”, “race”, and “sexual orientation”. At a second step, denoted 402b, code segment 400 may involve receiving of said source model, “SM1”, by a data structure variable, denoted “DS1”. At a third stage, denoted 402c, code segment 400 may involve generating a ML model, denoted “ML1”, from said data structure variable, “DS1”, using a “Fit” command.

In other cases, alternatively or additionally to the above, at least some of said one or more source data structures may be ML profiles (i.e., processes which add information to a given record or records, for example, an ML process that adds a “risk” label including value(s) related to said given record or records) generated from data structures other than said data structure.

By way of a non-limiting example, presented for purposes of better understanding the presently disclosed subject matter and in no way intended to limit the scope of the presently disclosed subject matter, system 200 obtains a plurality of theoretical labels including: race, ethnicity, gender, religion, sexual orientation, age, philosophical belief, political opinion, health, finances, height, weight, and address, each of which is considered an indicator of a potential bias, and the code segment 100 of FIG. 1.

Once the plurality of theoretical labels and the at least one code segment are obtained, system 200 extracts the plurality of actual labels from said data structure (block 304).

The plurality of actual labels may include one or more of: feature labels, target labels, and the like. Furthermore, the plurality of actual labels may be associated with additional labels that are also indicative of the content of data records associated with them. For example, the actual label “race”, which is indicative of an individual's race, may be associated with additional labels, “person.race”, “person.race1”, “individual.race” “race of a person”, and “individual's race”, which are permutations of said actual label “race”, and as such, are also indicative of the same.

Upon at least one actual label of the plurality of actual labels matching at least one theoretical label of the plurality of theoretical labels, system 200 performs an action associated with potential data bias identification (block 306).

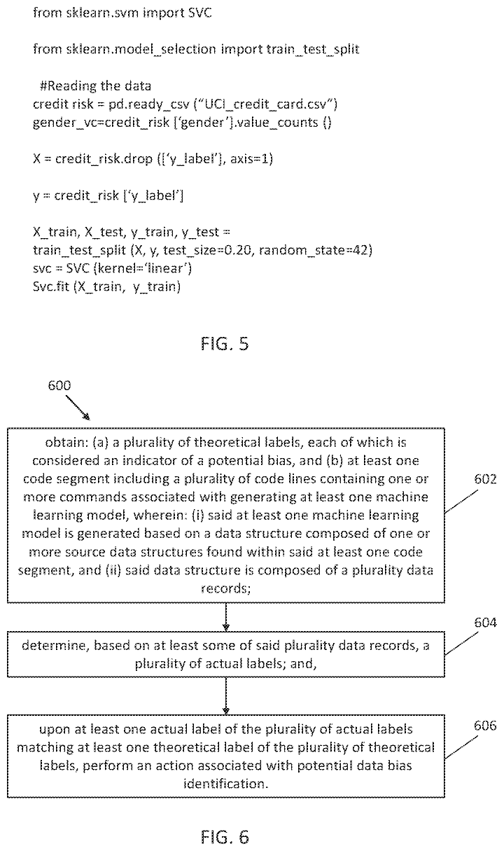

The action associated with potential data bias identification may be, for example, one or more of: alerting a user of said system that said machine learning model is potentially biased, flagging said at least one code segment as potentially biased, excluding said at least one actual label matching said at least one theoretical label, along with its associated data, from the data structure, and/or one of its source data structures, so as to cleanse said data structure (and/or one of its source data structures) from potentially biased labels (as illustrated, for example, in FIG. 5), and the like.

By way of example and in accordance with our non-limiting example above, system 200 extracts the labels of code segment 100 of FIG. 1 (i.e., “first name”, “last name”, “ID number”, “race”, and “sexual orientation”). Next, system 200 compares the extracted labels with the obtained plurality of theoretical labels. Since the labels “race” and “sexual orientation” are found within the obtained plurality of theoretical labels, system 200 provides its user with an alert that the machine learning model generated within code segment 100 is potentially biased.

In some cases, given that the source data structures composing said data structure may contain labels that are not part of the respective labels of the data structure, as optionally only at least some of their labels may be common to said data source, as mentioned hereinbefore, system 200 may extract these labels and compare them to the plurality of theoretical labels as well. In such cases, upon a match between at least one of the extracted labels and at least one of the theoretical labels, the system may also perform an action associated with potential data bias identification. For example, given two source data structures, “A” and “B”, each containing three feature labels, such that “A” contains “name” label, “race” label, and “address” label, while B contains “name” label, “address” label, “ID number” label, and given a data structure consisting of said source data structures and containing three feature labels, “name” label, “address” label, “ID number” label, system 200 compares not only the labels of the data structure (i.e., the “name” label, the “address” label, and the “ID number” label) to the plurality of theoretical labels but also the labels of source data structures, “A” and “B”. Since the “race” label of source data structure “A” matches one of the plurality of theoretical labels, system 200 provides its user with an alert that the machine learning model generated is potentially biased.

In some cases, the obtained at least one code segment may include a plurality of code flows, each including a plurality of code lines. In such cases, prior to the extracting of the plurality of actual labels, described hereinbefore, system 200 may identify at least one code flow of the plurality of code flows in which the data structure is present, and may operate only on it.

In some cases, alternatively to the above, as illustrated in FIG. 6, the data structure, on the basis of which the at least one machine learning model may be generated, may not inherently include a plurality of actual labels but rather a plurality of data records (optionally originated from test data, though other origins are also feasible) (block 602). In such cases, system 200 may determine a plurality of actual labels, based on values of at least some of the plurality of records (block 604), and once determined, proceed to the performing step (block 606). For example, the data structure may include a plurality of records, each having a respective value of either male or female, associated with a first column. Based on said respective values, system 200 may determine an actual label, “gender”, for said first column. Similarly, the data structure may include a plurality of records, each having a respective value of between 0 and 99, associated with a second column. Based on said respective values, system 200 may determine an actual label, “age”, for said second column.

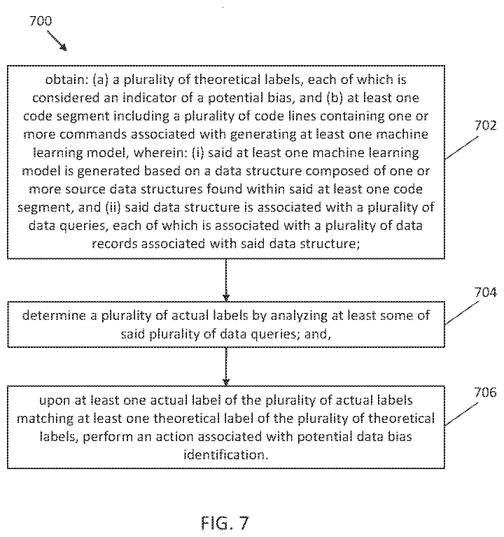

In some cases, alternatively to the above, as illustrated in FIG. 7, the data structure, on the basis of which the at least one machine learning model may be generated, may not inherently include a plurality of actual labels but rather a plurality of data queries, each of which is associated with a plurality of data records associated with said data structure (optionally originated from test data, though other origins are also feasible) (block 702). In such cases, system 200 may determine a plurality of actual labels by analyzing at least some of said plurality of data queries (block 704), and once determined, proceed to the performing step (block 706). For example, the data structure may include a data query “group by: male” performed on a first column of said data structure. Based on said data query, system 200 may determine an actual label, “gender”, for said first column. Similarly, the data structure may include a data query “group by: black” performed on a second column of said data structure. Based on said data query, system 200 may determine an actual label “race”, for said second column.

It is to be noted, with reference to FIGS. 3, 6, and 7, that some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for potential data bias identification, the system comprising a processing circuitry configured to:
obtain: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures;
extract the plurality of actual labels from said data structure; and,
upon at least one actual label of the plurality of actual labels matching at least one theoretical label of the plurality of theoretical labels, perform an action associated with potential data bias identification.

2. The system of claim 1, wherein said action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

3. The system of claim 1, wherein at least some of said one or more source data structures are Machine Learning (ML) models generated from data structures other than said data structure.

4. The system of claim 1, wherein at least some of said one or more source data structures are profiles generated from data structures other than said data structure.

5. The system of claim 1, wherein said one or more commands are one of: train, transform, fit_transform, or fit.

6. The system of claim 1, wherein said plurality of theoretical labels include one or more of: race, ethnicity, gender, religion, sexual orientation, age, philosophical belief, political opinion, health, finances, height, weight, or address.

7. The system of claim 1, wherein said plurality of theoretical labels is a dynamic list of indicators of a potential bias that is constantly updated.

8. The system of claim 1, wherein said plurality of actual labels include one of: feature labels, target labels, or a combination thereof.

9. The system of claim 1, wherein each actual label of the plurality of actual labels is associated with additional labels that are also indicative of the content of data records associated with said actual label.

10. The system of claim 1, wherein: (i) the at least one code segment includes a plurality of code flows, each including a plurality of code lines, and (ii) prior to the extracting step, the processing circuitry is configured to identify at least one code flow of the plurality of code flows in which the data structure is present.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method for potential data bias identification comprising:
obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures;
extracting the plurality of actual labels from said data structure; and,
upon at least one actual label of the plurality of actual labels matching at least one theoretical label of the plurality of theoretical labels, performing an action associated with potential data bias identification.

34. The method of claim 33, wherein said action is one of: alerting a user of said system that said machine learning model is potentially biased, flagging said at least one code segment as potentially biased, excluding said at least one actual label matching said at least one theoretical label, along with its associated data, from the data structure so as to cleanse said data structure from potentially biased labels, or any combination thereof.

35. The method of claim 33, wherein at least some of said one or more source data structures are Machine Learning (ML) models generated from data structures other than said data structure.

36. The method of claim 33, wherein at least some of said one or more source data structures are profiles generated from data structures other than said data structure.

37. The method of claim 33, wherein said one or more commands are one of: train, transform, fit_transform, or fit.

38. (canceled)

39. The method of claim 33, wherein said plurality of theoretical labels is a dynamic list of indicators of a potential bias that is constantly updated.

40. The method of claim 33, wherein said plurality of actual labels include one of: feature labels, target labels, or a combination thereof.

41. The method of claim 33, wherein each actual label of the plurality of actual labels is associated with additional labels that are also indicative of the content of data records associated with said actual label.

42. The method of claim 33, wherein: (i) the at least one code segment includes a plurality of code flows, each including a plurality of code lines, and (ii) prior to the extracting step, at least one code flow of the plurality of code flows in which the data structure is present, is identified.

43. A non-transitory computer readable storage medium having computer readable program code embodied therewith, the computer readable program code, executable by at least one processor to perform a method for potential data bias identification, the method comprising:
obtaining: (a) a plurality of theoretical labels, each of which is considered an indicator of a potential bias, and (b) at least one code segment including a plurality of code lines containing one or more commands associated with generating at least one machine learning model, wherein: (i) said at least one machine learning model is generated based on a data structure composed of one or more source data structures found within said at least one code segment, and (ii) said data structure is associated of a plurality of actual labels, each of which is common to at least one source data structure of said one or more source data structures;
extracting the plurality of actual labels from said data structure; and,
upon at least one actual label of the plurality of actual labels matching at least one theoretical label of the plurality of theoretical labels, performing an action associated with potential data bias identification.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
